(19) United States
(12) Patent Application Publication
(10) Pub. No.: US 2005/0062252 A1
(43) Pub. Date: Mar. 24, 2005

(54) Vehicle running board assembly

(76) Inventor: Ross Vincent, Tecumseh (CA)

Correspondence Address: Miller, Canfield, Paddock and Stone P.L.C.;c/o Robert Kelley Roth, Suite 2500, 150 West Jefferson Ave, Detroit, MI, 48226, US

(21) Appl. No.: 10/666,070

(22) Filed: Sep. 18, 2003

(51) Int. Cl. B60R 3/00

(52) U.S. Cl. 280/163

(57) ABSTRACT

An improved vehicle running board assembly comprises a structural frame having fore and aft edges and at least one connector adapted to connect the structural frame to a motor vehicle, and a step pad comprising a step and fore and aft legs extending from the step past the corresponding fore and aft edges of the structural frame, and the step pad is secured to the structural frame. The step pad may be formed by injection molding a thermoset resin around the structural frame.

### FIELD OF THE INVENTION

This invention relates to vehicle running board assemblies, and, more particularly, to vehicle running board assemblies used on sport utility vehicles and pickup trucks.

### BACKGROUND OF THE INVENTION

Vehicle running board assemblies are used on large vehicles such as pickup trucks and sport utility vehicles (“SUVs”) and the like to allow individuals to step up to enter the vehicle. Generally known designs for vehicle running boards have had some sort of pipe, typically metal, attached to the motor vehicle with a suitable attachment mechanism. The pipe would be cut to allow for attachment of a step pad, generally formed of some sort of rubber-like material. The step pad often has a ribbed or corrugated exterior or show surface which would help a person maintain traction as he stepped onto the step pad and into the vehicle. Older designs generally would use a load transmitting member which would rest on the bottom of the interior of the pipe, and the step pad would then fit over this load transmitting member and close the opening.

One example of an attempt to develop a low cost design for vehicle running board assemblies is taught in U.S. Pat. No. 5,713,589 to Delgado et al. Delgado et al discloses a step and an insert which transmits load down to the bottom of the interior of the pipe through a pipe opening cut into the pipe. In order to clear the opening formed in a pipe, the insert is inserted into the pipe opening and then rotated 90 degrees into its final position. Clearly, this makes for somewhat awkward assembly of the various components. Consequently, other designs have been developed to simplify such assembly.

U.S. Pat. Nos. 6,409,193 and 6,173,979 to Bernard teach a step pad having a support plate connected to the step pad by snap fit. The support plate acts as the primary load bearing element on the pipe, directly contacting the pipe at side edges of a pipe opening. V-shaped retaining ribs on the support engage an interior surface of the pipe. The step pad is shown to make sealing contact with the pipe, but is not designed to be a load bearing element. This design is advantageous in that it permits a straight drop assembly method, without need for relying on a rotational insertion.

Co-pending and commonly owned U.S. patent application Ser. No. 10/357,020 discloses another design for a load transmitting member positioned between the step pad and the pipe. It would be desirable to provide an improved vehicle running board assembly wherein material usage and costs may be reduced.

### SUMMARY OF THE INVENTION

In accordance with a first aspect, a vehicle running board assembly comprises a structural frame having fore and aft edges and at least one connector adapted to connect the structural frame to a motor vehicle, and a step pad comprising a step and fore and aft legs extending from the step past the corresponding fore and aft edges of the structural frame, wherein the step pad is secured to the structural frame. In accordance with another aspect, the step pad may be formed by injection molding molten plastic around the structural frame. Further, the step pad may be formed with a pocket to receive the structural frame.

From the foregoing disclosure and the following more detailed description of various preferred embodiments it will be apparent to those skilled in the art that the present invention provides a significant advance in the technology and art of vehicle running board assemblies. Particularly significant in this regard is the potential the invention affords for providing a high quality, low cost, running board assembly which reduces the number of parts required for assembly. Additional features and advantages of various preferred embodiments will be better understood in view of the detailed description provided below.

### BRIEF DESCRIPTION OF THE DRAWINGS

FIG. 1 is a perspective view of a representative SUV having an improved running board assembly in accordance with a preferred embodiment, showing a step pad with a pair of steps.

FIG. 2 is a fragmentary perspective view of another preferred embodiment showing the step pad with a single step and assembled to the structural frame.

FIG. 3 is an isolated view of the structural frame in accordance with the preferred embodiment of FIG. 2.

FIG. 4 is an underside isolated perspective view of the step pad of FIG. 2.

FIG. 5 is an isolated perspective view of a cover protecting the underside of the vehicle running board assembly of FIG. 2.

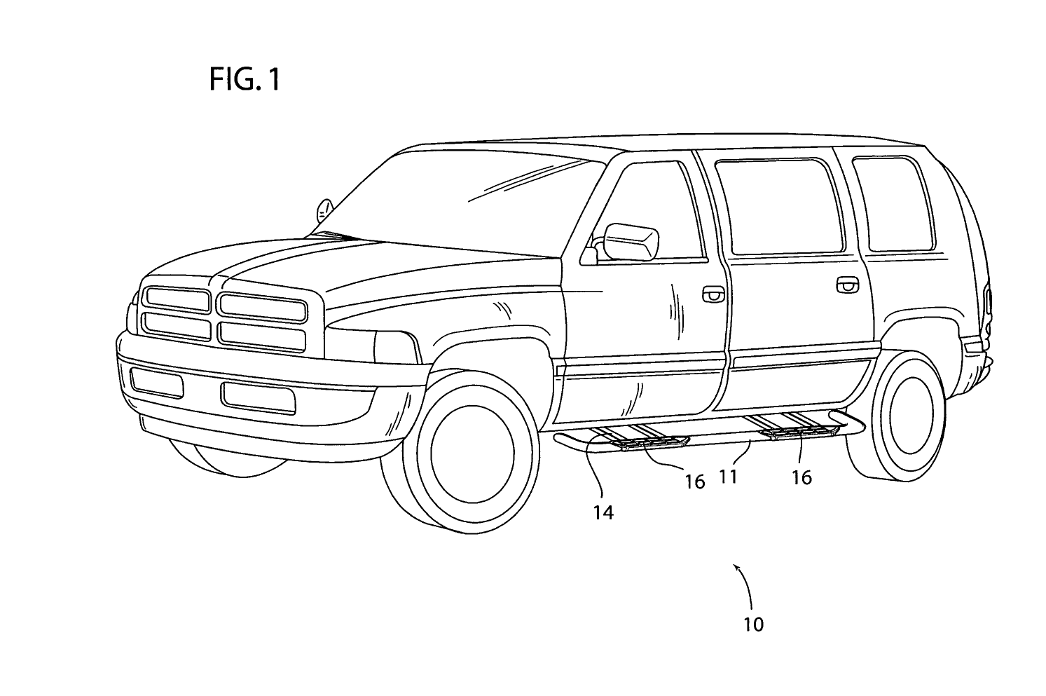

It should be understood that the appended drawings are not necessarily to scale, presenting a somewhat simplified representation of various preferred features illustrative of the basic principles of the invention. The specific design features of the vehicle running board assembly as disclosed here, including, for example, the specific dimensions of the step pad, will be determined in part by the particular intended application and use environment. Certain features of the illustrated embodiments have been enlarged or distorted relative to others to facilitate visualization and clear understanding. In particular, thin features may be thickened, for example, for clarity of illustration. All references to direction and position, unless otherwise indicated, refer to the orientation illustrated in the drawings. “Fore and aft” refers to the orientation of the vehicle running board assembly with respect to the vehicle shown in FIG. 1.

### DETAILED DESCRIPTION OF CERTAIN PREFERRED EMBODIMENTS

It will be apparent to those skilled in the art, that is, to those who have knowledge or experience in this area of technology that many uses and design variations are possible for the vehicle running board assembly disclosed here. The following detailed discussion of various alternative and preferred features and embodiments will illustrate the general principles of the invention with reference to a vehicle running board assembly suitable for use with a sport utility vehicle. Other embodiments suitable for other applications will be readily apparent to those skilled in the art given the benefit of this disclosure.

Referring now to the drawings, FIG. 1 shows a vehicle running board assembly 10 which helps a user to enter and exit the vehicle. The vehicle running board assembly comprises a step pad 11 and structural frame 12. The structural frame 12 is connected to a motor vehicle through one or more of a series of connectors 14; as shown in FIG. 1, the structural frame has 4 connectors. In accordance with a highly advantageous styling feature, the connectors 14 can be attached to the motor vehicle remote from the ends of the step pad. The step pad 11 can comprise at least one step 16; as shown in FIG. 1, the step pad has a pair of steps 16.

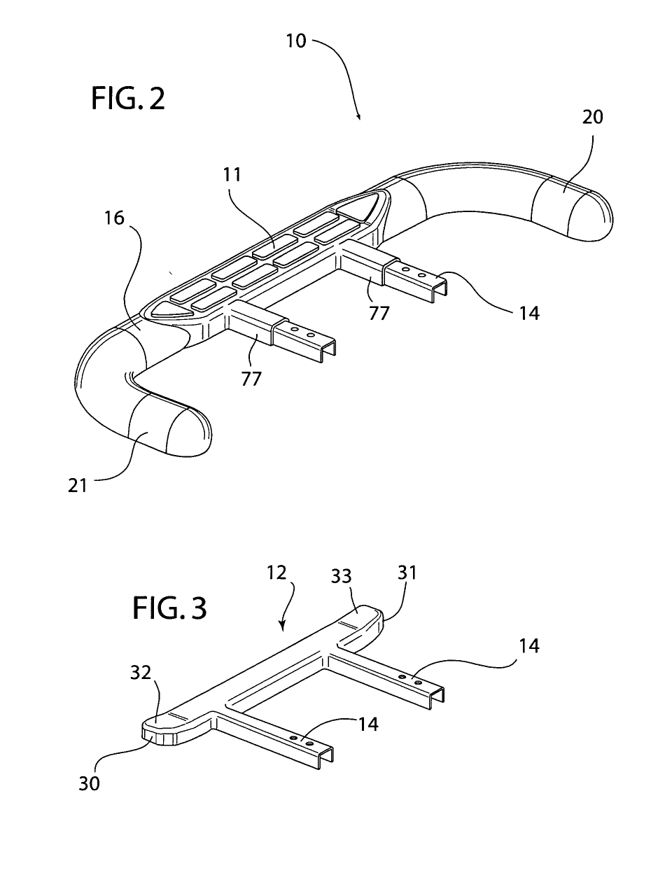

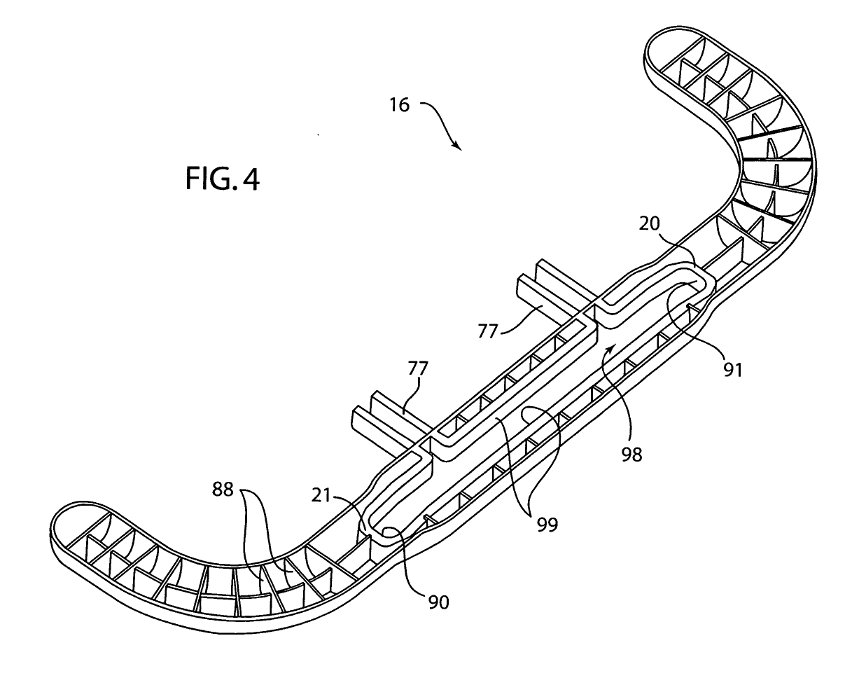

FIGS. 2-4 show an alternate preferred embodiment of a vehicle running board assembly 10 wherein the structural frame has a pair of connectors 14 and the step pad 11 has a single step 16. Step pad 11 has fore and aft legs 21, 20 which extend away from the structural frame and may wrap inward toward the vehicle. FIG. 3 is an isolated perspective view of the structural frame of FIG. 2, showing fore and aft flanges, 31, 30, having fore and aft edges 33, 32, respectively. FIG. 4 shows an underside isolated perspective view of the step pad. A pocket 98 is formed by side walls 99, 90 and 91. 91 and 90 are fore and aft underside walls which are adapted to at least partially wrap around corresponding fore and aft edges 33, 32 of the structural frame 12. To enhance the strength of the step pad without using extra materials the step pad may be provided with a plurality of reinforcing ribs 88, preferably positioned on the underside of the step pad and remote from the show surface that is normally visible to the user. The ribs are seen in FIG. 4 to extend both along the fore and aft flanges 21, 20 of the step pad, and between the flanges on either side of the pocket 98. The structural frame is preferably formed of a metal, for example, a metal stamping. Step pad 11 may be formed of a thermoset resin so that the step 16 and fore and aft legs 21, 20 are all formed of a single, one-piece or unitary construction. Suitable materials for the step pad include plastics such as glass filled polyesters, PP, ASA and ABS. Other materials suitable for use as the step pad will be readily apparent to those skilled in the art given the benefit of this disclosure.

In accordance with a highly advantageous feature, the fore and aft legs of the step pad extend from the step 16 past the corresponding fore and aft edges of the structural frame, and the step pad is secured to the structural frame, preferably by injection molding the step pad over the structural frame. Irrespective of how the step pad is formed, the fore and aft walls 91, 90 of the pocket are preferably sized to snugly receive the fore and aft edges of the legs 31, 30 of the structural frame.

As seen best in FIGS. 2 and 4, preferably extending from the step 16 of the step pad are side flanges 77. Each side flange at least partially surrounds a corresponding connector 14 to the motor vehicle. Where the step pad is insert molded, the side flange at least partially encapsulates the corresponding connector.

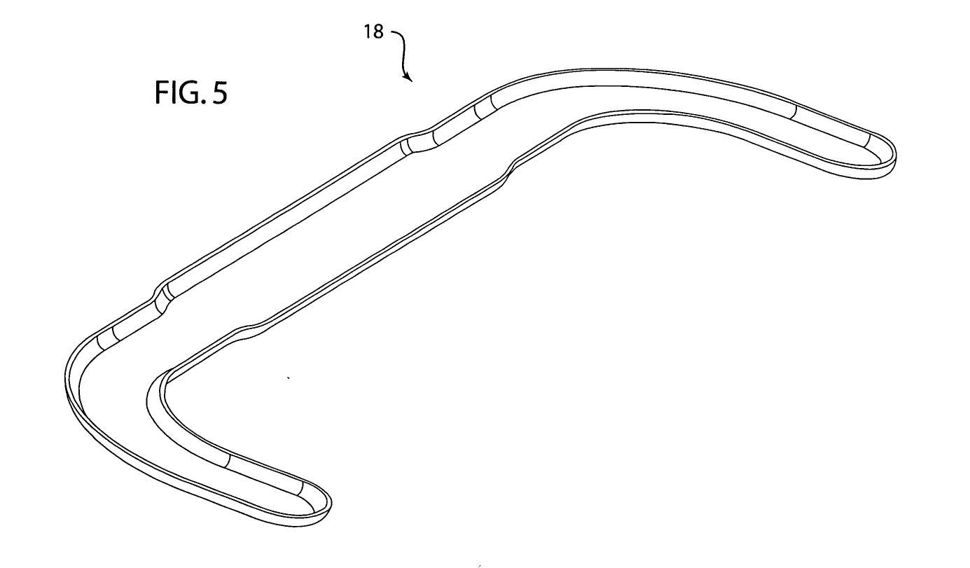

Advantageously, forming the vehicle running board assembly in this manner eliminates the need for performing secondary operations on a pipe and it eliminates the need for a separate structural member positioned between the step pad and the structural member. An underside cover 18, shown in FIG. 5, can be used with the step pad to at least partially enclose the structural frame 12. The cover may be connected to the step pad by sonic welding, for example.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A vehicle running board assembly comprising, in combination:
a structural frame having fore and aft edges and at least one connector adapted to connect the structural frame to a motor vehicle; and
a step pad comprising a step and fore and aft legs extending from the step past the corresponding fore and aft edges of the structural frame, wherein the step pad is secured to the structural frame.

2. The vehicle running board assembly of claim 1 wherein the step and the fore and aft legs of the step pad are formed of unitary construction.

3. The vehicle running board assembly of claim 1 further comprising reinforcing ribs formed on an underside of the step pad.

4. The vehicle running board assembly of claim 3 wherein the reinforcing ribs are on the fore and aft legs of the step pad.

5. The vehicle running board assembly of claim 1 further comprising an underside cover which cooperates with the step pad to enclose the structural frame.

6. The vehicle running board assembly of claim 1 wherein the structural frame has fore and aft flanges ending at the corresponding fore and aft edges, and the step pad further comprises walls formed on an underside of the step pad, forming a pocket which snugly receives fore and aft flanges of the structural frame.

7. The vehicle running board assembly of claim 1 comprising fore and aft walls formed on an underside of the step pad, which extend past the corresponding fore and aft edges of the structural frame.

8. The vehicle running board assembly of claim 1 comprising fore and aft walls formed on an underside of the step pad which at least partially wrap around the corresponding fore and aft edges of the structural frame.

9. The vehicle running board assembly of claim 1 wherein the step pad is formed by injection molding molten plastic around the structural frame.

10. A vehicle running board assembly comprising, in combination:
a structural frame having fore and aft edges and at least one connector adapted to connect the structural frame to a motor vehicle; and
a plastic step pad comprising a step and fore and aft legs extending from the step;
wherein the step pad is formed by injection molding molten plastic around the structural frame.

11. The vehicle running board assembly of claim 10 wherein the structural member is a metal and the step pad is a thermoplastic resin.

12. The vehicle running board assembly of claim 10 wherein the step pad has at least one side flange at least partially encapsulating a corresponding one of the at least one connectors.

13. A vehicle running board assembly comprising, in combination:
a structural frame having fore and aft legs and at least one connector adapted to connect the structural frame to a motor vehicle; and
a step pad comprising a step and walls formed on an underside of the step pad, forming a pocket which snugly receives fore and aft legs of the structural frame.

14. The vehicle running board assembly of claim 13 wherein the step pad walls comprise a pair of side walls and fore and aft walls, and an underside cover cooperates with the step pad to at least partially enclose the structural frame.
